(19) United States
(12) Patent Application Publication
(10) Pub. No.: US 2014/0109858 A1
(43) Pub. Date: Apr. 24, 2014

(54) Distributor Incorporating a Heat Exchanger and its Manufacturing Process

(71) Applicant: SYSTEMES MOTEURS, LEVALLOIS-PERRET (FR)

(72) Inventors: Benoit ANCEL, EGUISHEIM (FR); Nicolas BECKER, COLMAR (FR)

(73) Assignee: SYSTEMES MOTEURS, LEVALLOIS-PERRET (FR)

(21) Appl. No.: 14/056,302

(22) Filed: Oct. 17, 2013

(30) Foreign Application Priority Data
Oct. 19, 2012 (FR) 1259972

(51) Int. Cl. F02M 35/104

(52) U.S. Cl. CPC F02M 35/104
USPC 123/184.61; 123/184.21; 29/890.03

(57) ABSTRACT

A distributor incorporates a heat exchanger mounted in the interior space of the distributor while being made integral with the wall of the body of the distributor by at least one side flange. The distributor is characterized in that its two constituent parts (5 and 5′) are joined by welding opposing joining edges (6 and 6′), the edges (6, 6′) being connected physically to one another in an airtight manner along a contact area (7) in the form of a peripheral continuous band, surrounding the outer periphery of the flange (4), and mechanically connected, in a localized and discontinuous way, to the flange (4) by engagement at through openings (8) and/or at deformed or radius-chamfered areas of the latter. A process of manufacturing the distributor is also described.

### FIELD OF THE INVENTION

This invention relates to the field of technical equipment of automobiles with internal combustion engines, more particularly the elements and components forming the intake line of the combustive gases of these engines.

In this context, the invention has as its object an intake manifold incorporating a heat exchanger.

### BACKGROUND OF THE INVENTION

Numerous embodiments of intake manifolds are known in the state of the art. It is the same for heat exchangers, in particular those intended to cool the EGR gases before they are mixed with fresh air, for the injection of the resulting gaseous mixture in the cylinders.

A constant demand, indeed a standing design constraint, in the field of automobile manufacturing, is the savings of space in particular under the hood and in the environment of the engine.

Within the framework of this general problem, a strong tendency aims at the incorporation of several complementary, associated and/or consecutive functions in the same structural module or the same structural unit.

Thus, it has been proposed to combine the “intake manifold” and “heat exchanger” functions in the same module, and different solutions of embodiment of this type of unitary and multifunctional module have already been disclosed.

In the state of the art, intake manifolds are particularly known for internal combustion engines that incorporate at least one heat exchanger mounted in the interior space of said manifold.

Consequently, said interior space is separated into two compartments located on both sides of said exchanger, and the flow of gas circulating in the manifold passes through said exchanger to go from a first of said compartments toward the second compartment.

Two major problems occur in this type of composite design (combined module: distributor+incorporated exchanger): namely, the rigid holding of the exchanger in the body of the distributor and the maintaining of the gas-tightness of the body of the distributor.

A related problem can come from the necessity of making the peripheral interface airtight between the exchanger and the body of the distributor, so as to force the gas stream to pass through the exchanger and thus to optimize the action of the latter.

According to a first known embodiment of intake manifolds forming combined modules, for example illustrated by the documents US 2011/0088663 and WO 2011/061311, the incorporated exchanger is made in situ in cooperation with the body of the manifold, certain parts used simultaneously in the exchanger and in the manifold.

In this first type of embodiment, the operating parts of the exchanger are assembled with the walls of the manifold while producing a double airtightness, namely the airtightness of the exchanger itself and the airtightness of the latter with respect to the manifold.

A complexity results of design and of very high production and mounting constraints, resulting in considerable production costs.

According to a second known embodiment, the heat exchanger is produced separately and then mounted in the body of the distributor when the latter is already in large part assembled (cf. WO 2008/061850, DE 10 2007 030 464, WO 2009/027492 or FR 2 645 209) or while being incorporated during assembling of the different parts of the distributor (cf. FR 2 936 572, WO 2011/064087 or FR 2 908 833). In this second type of known embodiment, the holding in position of the exchanger is achieved by locking in the body of the distributor or by being made integral with the wall of the latter, the airtightness of the distributor being managed independently.

This leads to the necessity for a correlation of the shapes of the exchanger and of the manifold and/or for the provision of particular anchoring sites of the exchanger, as well as specific fastening means.

Moreover, several consecutive assembling/mounting operations are necessary.

Finally, by the document EP 0 343 565, an intake manifold or distributor for an internal combustion engine, in particular supercharged, is known, said distributor incorporating at least one heat exchanger mounted in the interior space of said distributor while being made integral with the wall of the body of the manifold by at least one lateral flange. The body of the distributor is made of two constituent hollow parts joined to one another in an airtight manner at opposed peripheral edges and having a mutually corresponding configuration, with insertion of the flange of the exchanger.

In this known distributor, the mounting of the exchanger and the airtight assembling of the constituent parts of the body of the distributor are obtained by a single combination of means, by a single assembling operation, and by the use of a single area of interfacing between the exchanger and the body of the manifold.

However, this latter solution again uses a plurality of parts, particularly two seals, and a plurality of fastening means (screws). In addition, the assembly process is relatively tedious to carry out.

### SUMMARY OF THE INVENTION

This invention essentially has as its object to propose a simpler solution and using fewer parts and pieces than the one disclosed by EP 0 343 565.

For this purpose, the invention proposes a distributor of the type described above, characterized in that its two constituent parts are joined by material bonding, preferably welding of the opposing joining edges, said edges being, on the one hand, connected physically to one another in an airtight manner (directly or indirectly) along a continuous peripheral contact area, surrounding the outer periphery of said flange, and, on the other hand, mechanically connected to said flange by engagement or by being made integral at through openings and/or at areas of hooking or of bonding with the latter.

### BRIEF DESCRIPTION OF THE DRAWINGS

The invention will be better understood, with the help of the description below, which relates to a preferred embodiment, given by way of nonlimiting example, and explained with reference to the accompanying diagrammatic drawings, in which:

FIGS. 1 and 2 are respectively diagrammatic representations, in cutaway, of a distributor with an exchanger according to an embodiment of the invention, respectively seen in side elevation (FIG. 1) and from above (FIG. 2), illustrating two variants of joining of the constituent parts of the distributor and of the exchanger,

FIG. 2A is a detail view on a different scale of the assembly area of the distributor with the exchanger illustrated in FIG. 2,

FIG. 3 is a view in the direction DE of the exchanger alone, mounted while being structurally incorporated into the distributor represented in FIGS. 1 and 2, and,

FIG. 4 is a detail view on a different scale illustrating another embodiment of the invention, in particular an additional variant of the assembly of the constituent parts of the distributor and of the exchanger.

### DETAILED DESCRIPTION OF THE INVENTION

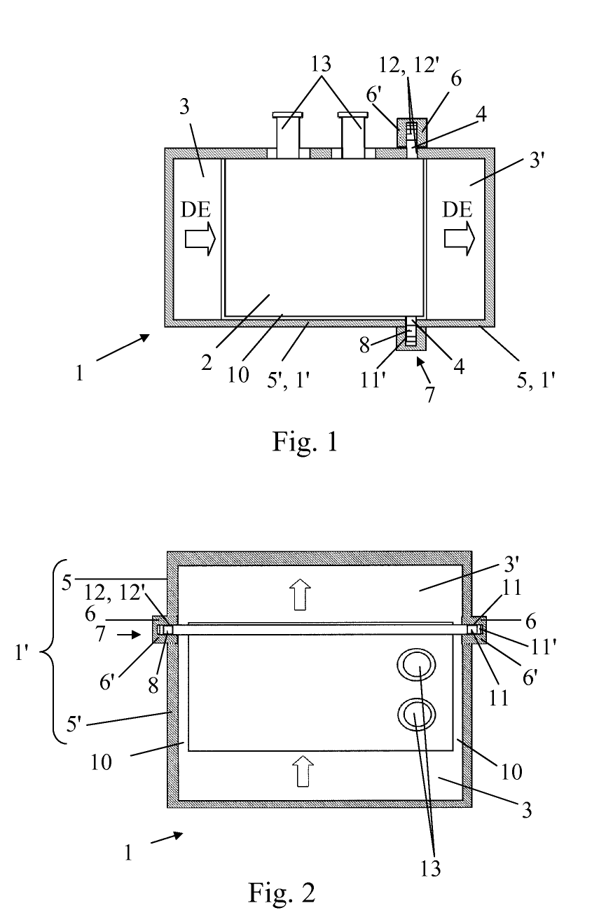

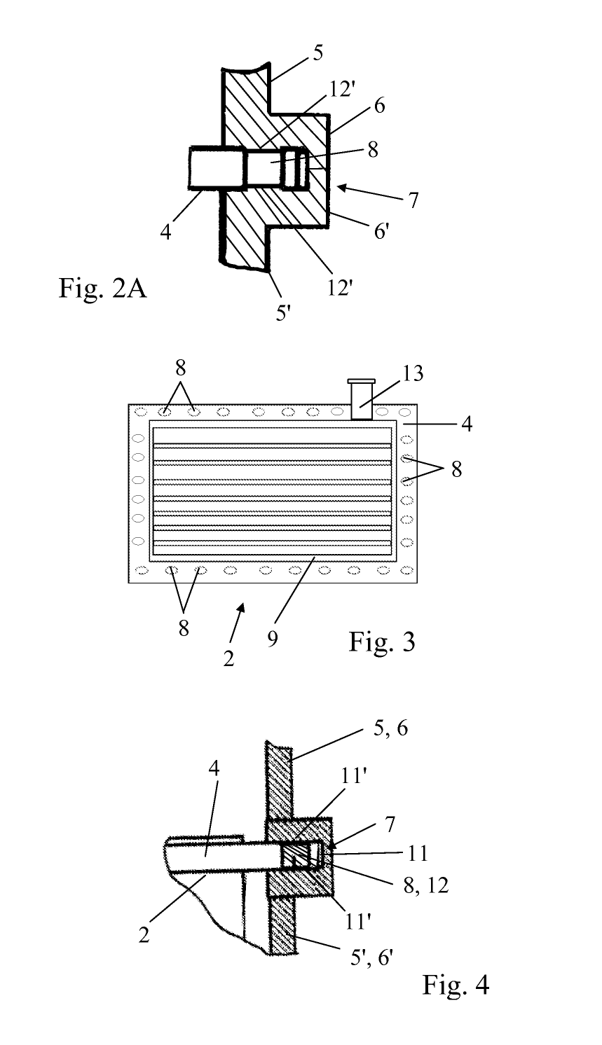

FIGS. 1 and 2 show a distributor or intake manifold 1 for an internal combustion engine, in particular supercharged, said distributor 1 incorporating at least one heat exchanger 2 mounted in the interior space of said distributor 1 while being made integral with the wall of the body 1′ of the distributor by at least one lateral flange 4. The body 1′ of the distributor is made of at least two constituent hollow parts 5, 5′ joined to one another in an airtight manner at opposed peripheral edges 6, 6′ and having a mutually corresponding configuration, with insertion of the flange 4 of the exchanger 2.

According to the invention, the two constituent parts 5 and 5′ are joined by welding of said opposing edges 6, 6′, said edges 6, 6′ being, on the one hand, connected physically to one another (directly or indirectly) in an airtight manner along a continuous peripheral contact area 7 (ring-shaped), surrounding the outer periphery of said flange 4, and, on the other hand, mechanically connected to said flange 4 by engagement or being made integral by material hooking at through openings 8 and/or at deformed or radius-chamfered areas of the latter, or else areas or faces of hooking or bonding.

The airtight joining of the parts 5, 5′ of the body 1′ of the distributor 1 and the rigid mounting of the exchanger 2 in the latter are thus achieved without using an additional sealing or fastening part and while concentrating the technical operations on a single area of the combined module (distributor 1+exchanger 2). Furthermore, the two above-mentioned operations can be performed simultaneously in a single operating phase.

The material bond between the two edges 6 and 6′ can consist of a bond by direct welding, for example by vibration welding or mirror welding.

In this case, and as FIGS. 2 and 2A show, the material of the edges 6 and 6′ themselves can, by itself, form the contact area 7, i.e., totally envelop the flange 4 and engage through or by hooking at the openings 8 or at the equivalent hooking areas (for example, lancing, projections, wings, baffles, borders or the like formed/made in the edge 4), being made integral in a manner that is distributed and localized by sites.

As FIG. 1 shows in a variant, the edges 6 and 6′ can also engage at the openings 8 of the flange 4 and optionally be connected physically to one another through them (the material of the edges 6, 6′ fusing and running out into these openings 8 during the joining by vibration welding, for example).

To guarantee the airtightness of the joining of the two parts 5 and 5′, to cover the projecting outer edge of the flange 4, and to furnish an indirect (if necessary, additional) physical bond between the edges 6 and 6′, provision can be made to perform an over-molding that envelops said flange 4 on the outside and that forms the contact and bridging area 7 between the two parts 5 and 5′.

Finally, according to another variant embodiment that is evident from FIG. 4, it can be envisaged that the flange 4 entails a thermoplastic over-molding before its joining with the body 1′ of the distributor 1. The over-molded material is then made integral (in an airtight manner, by welding) with the edges 6 and 6′ during the joining of the constituent parts 5 and 5′ and forms the contact area 7 between its edges 6 and 6′, which are then connected indirectly to one another.

The thorough bonding process between the flange 4 and the edges 6, 6′ of the parts 5, 5′ thus takes place by partial or total encapsulation of the flange 4 between the edges 6, 6′, but also by engagement of the thermoplastic material of these edges 6, 6′ in the openings 8 (hooking by lugs or fingers of material 12′ or by through bridges of material 12, following the partial fusing of said edges 6, 6′ with insertion of the flange 4).

Advantageously and as FIG. 3 shows, the or each flange 4 is a surrounding peripheral flange that extends over the entire lateral periphery of the exchanger 2, the through openings 8 being preferably distributed over the entire flange 4.

Thus, the or each surrounding peripheral flange 4 can constitute a support frame and/or a structural reinforcement for the exchanger 2 and simultaneously a stiffening insert for the body 1′ of the distributor 1, to which it is thoroughly connected, by overlapping and multiple mechanical engagements.

In practice, the flange(s) 4 each consist(s) preferably of a wing of sheet metal added to or formed in one piece with an outer envelope 9 of the heat exchanger 2, said wing 4 being advantageously located near one of the ends, in the direction of flow DE of the gas stream, of the exchanger 2.

Of course, unlike the embodiment shown in the accompanying figures, several flanges 4 spaced along the exchanger 2 can be provided, for example a surrounding flange 4 as shown in FIGS. 1 to 3 and one or more flanges 4 in the form of lugs or tabs located at the other end of the exchanger 2 and resting against the wall of the part 5′ or fastened to the latter before joining of the two parts 5 and 5′ (not shown).

The flange 4 can, furthermore, when it is provided in the form of a surrounding peripheral frame, perform a secondary function of piping of the gas stream through the exchanger 4 while preventing the bypass leaks (through the possible free spaces or gaps between the body of the exchanger 2 and the walls of the body 1′ of the manifold 1).

In this case and as FIGS. 1 and 2 show, the peripheral flange 4 is connected in an airtight manner to the outer envelope 9 of the exchanger 2 that delimits, in the normal direction of flow DE of the gas stream, a laterally airtight portion of passage in the distributor 1, the gap 10 between this envelope 9 and the wall of the body 1′ of the distributor 1 being blocked by said peripheral flange 4 whose through openings 8 are all located between the edges 6, 6′ joined by welding.

When the flange 4 does not perform this internal airtightness function, it can be envisaged to use specific airtightness means, separate from the flange 4, for example of the type of those described in French Patent Application No. 12 59928 of Oct. 18, 2012 in the name of the applicant.

Consistent with a practical variant embodiment that is evident from FIGS. 1 and 2, the two constituent parts 5, 5′ entirely form the body 1′ of the distributor 1 and are made of a thermoplastic material, these parts 5, 5′ being joined by local fusing and heat welding of the material of the opposing edges 6, 6′, for example by vibration welding (the thermoplastic material can, for example, be polyamide or polypropylene, optionally loaded with fibers or the like).

To achieve a better fit and a better overlapping of the flange 4 in the body 1′ of the distributor 1, each edge can be provided with a radiused chamfer 11 that forms, by cooperation with the radiused chamfer of the opposing edge 6, 6′, at least one receiving throat blank 11′ for the flange 4 in the shape of a plate.

As a variant, a single radiused chamfer 11 can be provided at one of the two edges 6, 6′ only.

Alternatively, the welding can also be performed by addition of material, for example by over-molding.

In any case, the invention also aims at obtaining a physical overlapping between the edges 6, 6′ and the flange 4 by engagement of material of at least one, preferably of both, of the edges 6 and 6′ in the openings 8 of the flange 4.

For this purpose, at least one, preferably both, of the edges 6 and 6′ can have lugs intended to be engaged in the openings 8 (these lugs can optionally contribute to a pre-mounting of the exchanger 2 on one of the parts 6, 6′ before the latter are joined).

As a variant, a surplus of material can be provided at the edges 6, 6′, said surplus forming during the fusing of the material, at the time of the joining by welding, projections that engage in the openings 8.

When the above-mentioned surplus of material is present in sufficient quantity, the two edges 6, 6′ that are mutually in contact can also be connected directly to one another by bridges of material 12 that extend through at least some of the through openings 8 present in the flange 4. Thus, the strength of the joining can be greatly increased as well as that of the connection between the flange 4 and the body 1′.

As already indicated above, the contact area 7, which surrounds and covers the flange 4 on the outside, can either be produced by the material of the edges 6 and 6′ or can consist of an over-molding of the flange 4, with a material that is compatible with that of the parts 5, 5′ that constitute the body 1′ of the manifold.

The invention also has as its object a process for manufacturing a manifold or distributor 1 that incorporates at least one heat exchanger 2 as described above.

This process is characterized in that it consists in supplying, on the one hand, two constituent parts 5 and 5′ of a body 1′ of a manifold or distributor 1 that are provided with peripheral joining edges 6 and 6′ of complementary symmetrical configurations and, on the other hand, a heat exchanger 2 comprising at least one side flange 4 and having a shape and dimensions suited for a mounting in a portion of the space delimited by the two parts 5 and 5′ in the assembled state, in placing said constituent parts 5 and 5′ and said exchanger 2 in a welding mold or template in such a way that the flange(s) 4 is (are) placed between the opposing joining edges 6 and 6′ of said parts 5 and 5′, in then performing the welding operation in such a way that said edges 6, 6′ are, on the one hand, connected physically to one another in an airtight manner along a contact area 7 in the shape of a peripheral continuous band, surrounding the outer periphery of said flange 4, and, on the other hand, connected mechanically, in a localized and discontinuous way, to said flange 4 by engagement at through openings 8 and/or at deformed or radius-chamfered areas of the latter and, finally, in extracting the composite piece forming a distributor 1 or a distributor part, and optionally in subjecting it to at least one additional manufacturing or finishing operation.

The exchanger 2 can advantageously be pre-mounted in one 5′ of the parts 5 and 5′ of the body 1′, for example the one comprising the openings for the passage of connecting end pieces 13 of the exchanger 2. The particular airtightness devices can optionally be provided at the openings.

The interior space of the hollow body 1′ of the distributor 1 exhibits, after the combined module is produced, three separate regions, namely a central region occupied by the exchanger 2 and two empty peripheral regions 3 and 3′ located respectively in the two constituent parts 5 and 5′, separated by the exchanger 2 and used in the circulation of the gaseous fluid.

Advantageously, the welding operation is a vibration welding operation, the two constituent parts 5, 5′ being made of a thermoplastic material and each joining edge 6, 6′ being preferably provided with a radiused chamfer 11 that forms, by cooperating with the radiused chamfer of the opposing edge 6, 6′, at least one receiving throat blank 11′ for the flange 4 in the shape of a plate.

Preferably, the process consists in supplying an exchanger 2 with an airtight outer envelope 9 and a surrounding peripheral flange 4 in the form of a wing made in one piece with or added to said envelope 9, and connected to the latter in an airtight manner.

Of course, the invention is not limited to the embodiment described and shown in the accompanying drawings. Modifications remain possible, particularly from the viewpoint of the make-up of the various elements or by substitution of technical equivalents, without thereby going outside the field of protection of the invention.

1. Distributor or intake manifold for an internal combustion engine, in particular supercharged, said distributor incorporating at least one heat exchanger mounted in the interior space of said distributor while being made integral with the wall of the body of the distributor by at least one lateral flange, the body of the distributor being made of at least two constituent hollow parts joined to one another in an airtight manner at opposing peripheral edges and having a mutually corresponding configuration, with insertion of the flange of the exchanger, the distributor (1) characterized in that its two constituent parts (5 and 5′) are joined by physical bonding, preferably welding, of said opposing joining edges (6 and 6′), said edges (6, 6′) being, on the one hand, connected physically to one another in an airtight manner, directly or indirectly, along a continuous peripheral contact area (7), surrounding the outer periphery of said flange (4), and, on the other hand, mechanically connected to said flange (4) by engagement or by being made integral at through openings (8) and/or at areas of hooking or of bonding with the latter.

2. Distributor or manifold according to claim 1, wherein the or each flange (4) is a surrounding peripheral flange that extends over the entire lateral periphery of the exchanger (2), the through openings (8) being preferably distributed over the entire flange (4).

3. Distributor or manifold according to claim 1, wherein the flange(s) (4) each consist(s) of a wing of sheet metal added to or formed in one piece with an outer envelope (9) of the heat exchanger (2), said wing (4) being advantageously located near one of the ends, in the direction of flow (DE) of the gas stream, of the exchanger (2).

4. Distributor according to claim 3, wherein the peripheral flange (4) is connected in an airtight manner to the outer envelope (9) of the exchanger (2) that delimits, in the normal direction of flow (DE) of the gas stream, a laterally airtight portion of passage in the distributor (1), the gap (10) between this envelope (9) and the wall of the body (1′) of the distributor (1) being blocked by said peripheral flange (4) whose through openings (8) are all located between the edges (6, 6′) joined by welding.

5. Distributor according to claim 1, wherein the two constituent parts (5, 5′) entirely form the body (1′) of the distributor (1) and are made of a thermoplastic material, these parts (5, 5′) being joined by local fusing and heat welding of the material of the opposing edges (6, 6′), for example by vibration welding, with the formation of the contact area (7), and
wherein each edge (6, 6′) is provided with a radiused chamfer (11) that forms, by cooperation with the radiused chamfer of the opposing edge (6, 6′), at least one receiving throat blank (11′) for the flange (4) in the shape of a plate.

6. Distributor according to claim 1, wherein the contact area (7) consists of an over-molding of the flange (4), with a material that is compatible with that of the parts (5, 5′) that constitute the body (1′) of the manifold.

7. Distributor according to claim 1, wherein the two edges (6, 6′) that are mutually in contact are also connected directly to one another by bridges of material (12) that extend through at least some of the through openings (8) present in the flange (4).

8. Process for manufacturing a manifold or distributor that incorporates at least one heat exchanger according to claim 1, wherein it consists in supplying, on the one hand, two constituent parts (5 and 5′) of a body (1′) of a manifold or distributor (1) that are provided with peripheral joining edges (6 and 6′) of complementary symmetrical configurations, and, on the other hand, a heat exchanger (2) comprising at least one side flange (4) and having a shape and dimensions suited for a mounting in a portion of the space delimited by the two parts (5 and 5′) in the assembled state, in placing said constituent parts (5 and 5′) and said exchanger (2) in a welding mold or template in such a way that the flange(s) (4) is (are) placed between the opposing joining edges (6 and 6′) of said parts (5 and 5′), in then performing the welding operation in such a way that said edges (6, 6′) are, on the one hand, connected physically to one another in an airtight manner along a contact area (7) in the shape of a peripheral continuous band, surrounding the outer periphery of said flange (4), and, on the other hand, connected mechanically, in a localized and discontinuous way, to said flange (4) by engagement at through openings (8) and/or at deformed or radius-chamfered areas of the latter, and, finally, in extracting the composite piece forming a distributor (1) or a distributor part, and optionally in subjecting it to at least one additional manufacturing or finishing operation.

9. Manufacturing process according to claim 8, wherein the welding operation is a vibration welding operation, the two constituent parts (5, 5′) being made of a thermoplastic material and each joining edge (6, 6′) being preferably provided with a radiused chamfer (11) that forms, by cooperating with the radiused chamfer of the opposing edge (6, 6′), at least one receiving throat blank (11′) for the flange (4) in the shape of a plate.

10. Manufacturing process according to claim 8, where it consists in supplying an exchanger (2) with an airtight outer envelope (9) and a surrounding peripheral flange (4) in the form of a wing made in one piece with or added to said envelope (9), and connected to the latter in an airtight manner.

11. Distributor or manifold according to claim 2, wherein the flange(s) (4) each consist(s) of a wing of sheet metal added to or formed in one piece with an outer envelope (9) of the heat exchanger (2), said wing (4) being advantageously located near one of the ends, in the direction of flow (DE) of the gas stream, of the exchanger (2).

12. Distributor according to claim 11, wherein the peripheral flange (4) is connected in an airtight manner to the outer envelope (9) of the exchanger (2) that delimits, in the normal direction of flow (DE) of the gas stream, a laterally airtight portion of passage in the distributor (1), the gap (10) between this envelope (9) and the wall of the body (1′) of the distributor (1) being blocked by said peripheral flange (4) whose through openings (8) are all located between the edges (6, 6′) joined by welding.

13. Manufacturing process according to claim 9, where it consists in supplying an exchanger (2) with an airtight outer envelope (9) and a surrounding peripheral flange (4) in the form of a wing made in one piece with or added to said envelope (9), and connected to the latter in an airtight manner.
